(19) United States
(12) Patent Application Publication
(10) Pub. No.: US 2004/0210447 A1
(43) Pub. Date: Oct. 21, 2004

(54) System and method for reporting an ergonomic condition based on self characterization

(76) Inventor: Anthony Michael Zingarelli, Orlando, FL (US)

Correspondence Address: DUANE MORRIS LLP, 100 COLLEGE ROAD WEST, SUITE 100, PRINCETON, NJ, 08540-6604, US

(21) Appl. No.: 10/419,290

(22) Filed: Apr. 18, 2003

(51) Int. Cl. G06F 17/60

(52) U.S. Cl. 705/1

(57) ABSTRACT

A user operating a computer system self-characterizing his interaction with at least one of the computer monitor, processor, keyboard, and mouse. The processor relates the self-characterization score to one or more predetermined ergonomic conditions, and produces a report recommending ways to ergonomically improve the interaction. In one version of the method, the processor also suggests products which may aid in the ergonomic improvement.

### FIELD OF THE INVENTION

This invention relates to evaluation and reporting of ergonomic conditions, such as ergonomic aspects of worker interrelation with the work environment, and more particularly to evaluation and reporting in relation to computer operation.

### BACKGROUND OF THE INVENTION

A great deal of attention has been directed toward workplace injuries, including those injuries resulting from repetitive stress (Repetitive Stress Injury or RSI) arising from excessive use of the joints. One such injury is carpal tunnel syndrome, which is believed to be related to typing over a long period of time or under adverse conditions, or both. Repetitive stress injury can be as debilitating as any other injury, and the cumulative costs of such injuries are such that it is desirable to take measures to ameliorate such injuries.

Various computer activity monitoring systems are known, including systems which monitor keyboard usage to evaluate the duration of employee work periods. U.S. Pat. No. 6,065,138, issued May 16, 2000 in the name of Gould et al., and assigned to Magnitude LLC, describes a computer activity monitoring system, which monitors the activity of the operator's or user's input device (keyboard or mouse) over a period of time. Various levels of work and/or rest are compared with limit values, and activity and/or rest status indicators are incremented or decremented according to the activity. A warning is issued to the user if the activity status reaches a predetermined alarm level. The user is thus advised to rest at times selected to reduce the incidence of RSI.

As implemented in ErgoSentry 4.01 software produced by Magnitude LLC, the user is provided with additional functionality, such as illustrations which depict various types of exercise which may reduce the effects of RSI. The software also provides functionality in the form of the ability of the user to self-evaluate, self-assess, or self-characterize various physical aspects of his interaction with the computer monitor, keyboard, and mouse. More particularly, ErgoSentry 4.01 provides illustrations of various poses and/or postures which a user might use, including both acceptable or “good” postures and/or poses, and various forms of “bad” postures and/or poses which are believed to lead to various forms of repetitive stress injury (RSI). The software allows the user to self-characterized his interaction with the computer monitor, keyboard and mouse, and also to self-characterize body locations that are painful, tender or sore, and to report the result of that assessment or characterization to the software program. The software processes the self-assesment input, and provides to the user a “score” representing or characterizing the degree of risk of injury.

Improved ergonomic software is desired.

### SUMMARY OF THE INVENTION

A system and method according to an aspect of the invention are provided for operating a system including a processor. The method includes the steps of providing a user of the system with the opportunity to self-characterized the interrelation of at least one user body part with the system, and using the processor to assign a score to the reported self-assessment. The processor is used to provide information, based on the score, about user condition and the interrelation of user with the system to reduce risk of injury. In a particular version of this aspect, the method further includes the step of presenting to the user a list including at least one corrective product which may be useful in the adjustment of the interrelationship. The system may include ancillary equipment associated with a computer processor. The ancillary equipment may include at least one of a monitor, chair, keyboard, mouse, ancillary input device, keyboard tray, and footrest.

According to another avatar of the invention, a computerized method for avoiding an ergonomic condition includes the steps of monitoring user operation and characterizing the user's mode of operation. This avatar also includes computerized assessment of the characterization, and generation of recommendations for ergonomic improvement of the mode of operation. In this avatar, a further step may include recommending to the user one or more products which may aid in the ergonomic improvement.

A further mode of the method of the invention includes operating a computer including at least a monitor, keyboard, or mouse. The method of this mode includes the steps of (a) receiving from a user self-characterized of the user's manner of operation of at least one of the monitor, keyboard, mouse, or other associated ergonomically important elements, (b) using the computer, evaluating the self-characterization to produce a score indicative of risk of injury due to interaction of the user with the monitor, keyboard, mouse, or other associated ergonomically important element, and (c) assessing the worker based upon the score and the self-assessment, and recommending means for correction of the interaction of the user with the monitor, keyboard, mouse, or other associated ergonomically important element. In another version of this mode, the step of assessing the worker includes assessing the condition of the worker. The step of recommending means for correction may be performed with the aid of an assessment database. This mode may include the step of (d) relating the means for correction to at least one corrective product of a database of corrective products. The corrective products may include one or more of an ergonomic keyboard, keyboard tray, mouse, chair, and footrest.

In a further manifestation of the invention, a method includes providing a user of an equipment with the opportunity to self-characterize the interrelation of at least one user body part with the equipment, and, using a processor, assigning a score to the reported self-characterization. The method according to this further manifestation further includes using the processor and in response to the score, providing information about user condition and interrelation of the user with the equipment to reduce risk of injury.

An embodiment of the invention includes a system including a processor and a working environment associated with the system. The system includes means for providing a user of the system with the opportunity to self-characterized the interrelation of at least one user body part with the working environment, and means, using the processor, for assigning a score to the reported self-characterization. The system of this embodiment also includes means, using the processor, and based on the score, for providing information about user condition and interrelation of user with the working environment to reduce risk of injury.

### BRIEF DESCRIPTION OF THE DRAWING

FIGS. 1a, 1b, and 1c together represent a simplified flow chart for three separate functions which may be performed by a prior-art user monitoring arrangement;

FIG. 2 illustrates a prior-art screen shot which allows the user to select from among a plurality of exercises in the arrangement of FIG. 1b, for which further information is available;

FIG. 3a represents a prior-art screen shot of a set of possible postures associated with the head, neck and upper body, to aid in self-assessment in conjunction with the flow chart of FIG. 1c, and FIG. 3b illustrates another screen shot associated with FIG. 1c;

FIG. 4 illustrates a prior-art screen shot in which the user may be advised of his risk of repetitive stress injury;

FIG. 5 is a simplified logic flow chart or diagram, illustrating steps according to an aspect of the invention;

FIG. 6a is a screen shot for presenting an assessment of high risk to the user's lower arm, FIGS. 6b, 6c, 6d, and 6e are screen shots for presenting an assessment of high risk to the user's neck, trunk, upper arm, and wrist, respectively, FIGS. 6f, 6g, 6h, and 6i, represent screen shots for presenting to the user an assessment of medium risk to the neck, trunk, upper arm, and wrist, respectively, and FIG. 6j represents a screen shot which advises the user of lowest risk;

FIG. 7 is a screen shot associated with a product ordering database according to an aspect of the invention; and

FIG. 8 is a simplified perspective or isometric view of a computer workstation.

### DESCRIPTION OF THE INVENTION

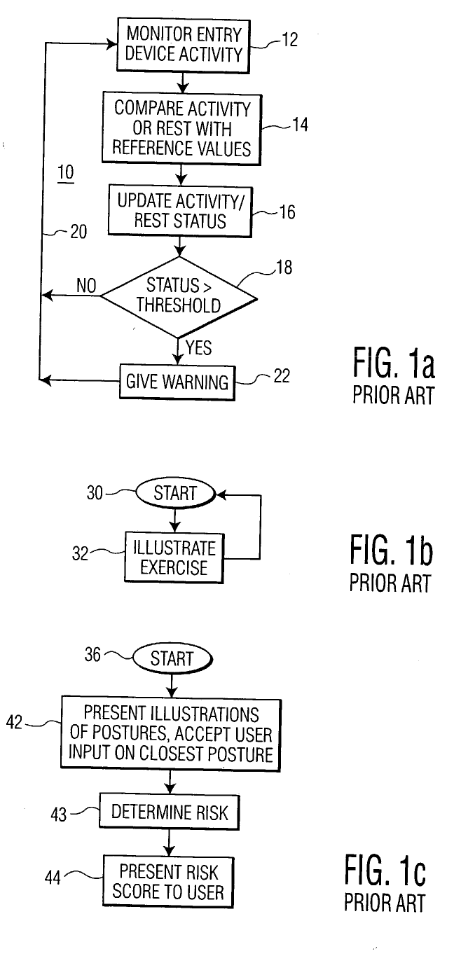

FIG. 1a is a simplified flow chart illustrating the user activity portion of the operation of the ErgoSentry 4.01 software produced by Magnitude LLC of [address]. In FIG. 1a, the logic iterates around a loop 10, which includes a block 12 representing monitoring of the user's activity in relation to a keyboard, mouse, or other entry device. The monitoring may involve the counting of keystrokes per minute, the timing of amount of mouse movement per minute, or other indications of activity. From block 12, the logic flows to a block 14, which compares the keystrokes per minute or mouse movement time per minute, for example, with predetermined threshold limits, to determine the level of activity or rest, as described in the abovementioned Gould et al. patent. The level of activity is used to update an activity status indicator and possibly a rest status indicator in a block 16. The updated status indicator(s) is(are) compared with thresholds in a decision block 18. If a threshold of activity over time is not exceeded, the logic leaves decision block 18 by the NO output, and proceeds by way of a logic path 20 back to block 12, for monitoring during the next interval. If the activity status exceeds the threshold, the logic leaves decision block 18 by way of the YES output, and arrives at a block 22, which represents the giving of a warning to the user or operator that he should rest or slow his activity.

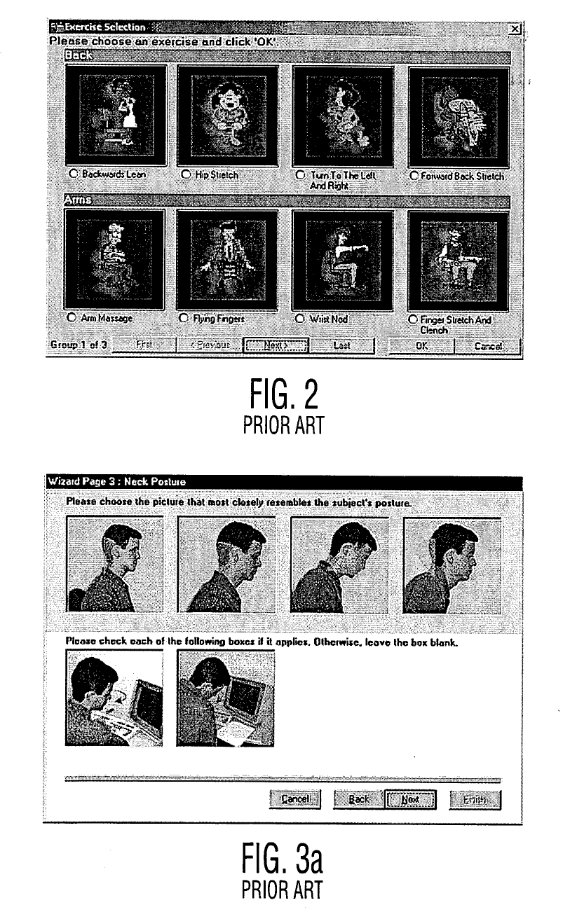

Concurrently with the monitoring operation described in conjunction with FIG. 1a, or separately therefrom, a separate function may be run in the ErgoSentry 4.01 software. This separate function is illustrated in FIG. 1b. When invoked, this function displays illustrations of various exercises which may aid in alleviating or mitigating the conditions which arise from the computer work environment. More specifically, block 30 of FIG. 1b represents the starting or invoking of this function, and block 32 represents the displaying of one or more illustrations showing such exercises. FIG. 2 illustrates a screen page or screen shot from which some such exercises can be selected, including backward lean, hip stretch, turns to the left and right, forward back stretch, arm massage, “flying fingers,” wrist nod, and finger stretch and clench.

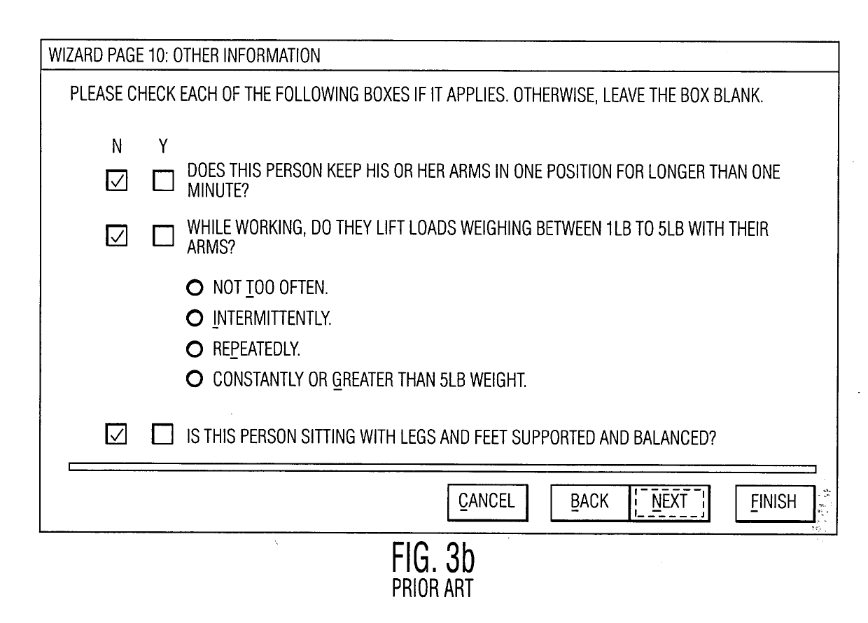

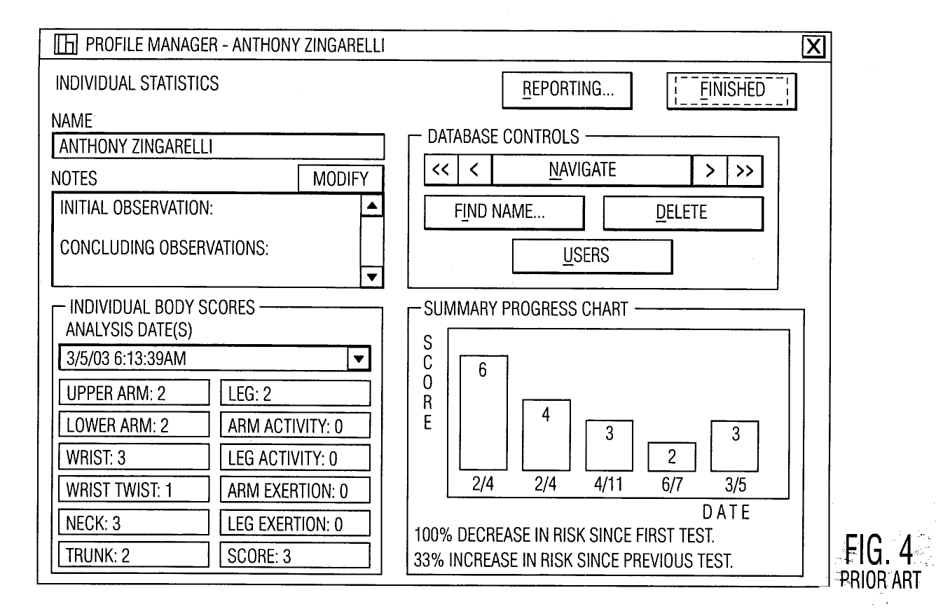

FIG. 1c represents another function which may be provided by the ErgoSentry 4.01, namely the function of providing for self-characterization of the user's ergonomic situation in the use of the computer, and the evaluation of the risk of repetitive stress injury (RSI). This is accomplished, as illustrated in FIG. 1c, by logic which, when invoked, begins at a START block 36, and proceeds to a block 42, which represents the display of one or more pages illustrating various postures, both good and bad, of the body, arms, legs, wrist, and fingers. FIG. 3a illustrates a screen shot of a posture display associated with block 42 of FIG. 1c. In FIG. 3a, various head and neck postures are illustrated, together with instructions to click on each picture which the user self-assesses as applying to his own situation. FIG. 3b illustrates another screen shot associated with block 42 of FIG. 1c, which invites the user to self-assess whether the arms are maintained in one position for a period longer than one minute, whether loads of greater than five (5) pounds (lb) are lifted with the arms often, intermittently, repeatedly, or constantly, or with greater than 5 lb. The screen page of FIG. 4b also asks for a self-assessment of whether the user sits with legs and feet supported and balanced.

When all the screens associated with block 42 of FIG. 1c have been displayed and appropriate responses have been made by the user, the information is assessed by the processor or computer in a block illustrated as 43, and the degree of risk of RSI to the user is given a numerical rating, ranging, for example, from one to five, with one being a low risk, and five being a high risk. Block 44 of FIG. 1c represents the presentation to the user of the rating, together with the ratings from previous evaluations of the same user. FIG. 4 illustrates a screen shot associated with block 44 of FIG. 1c.

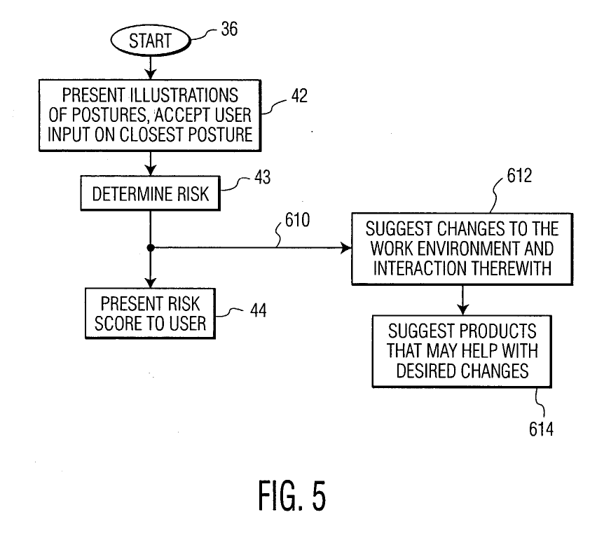

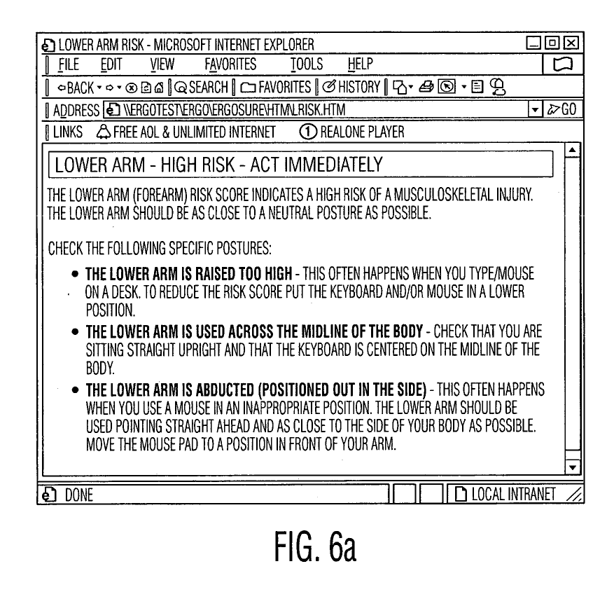

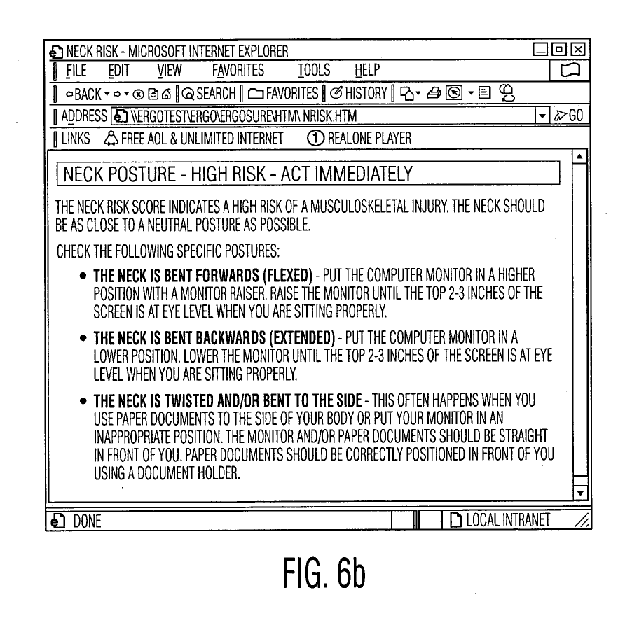

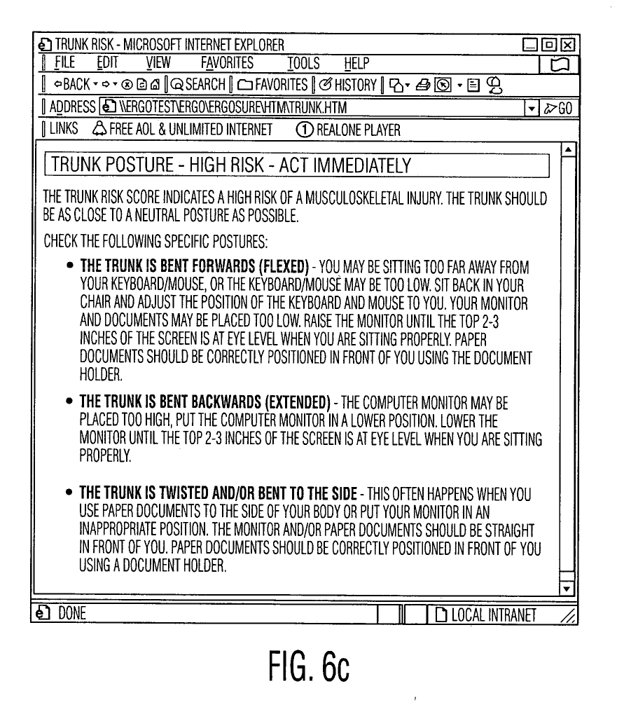

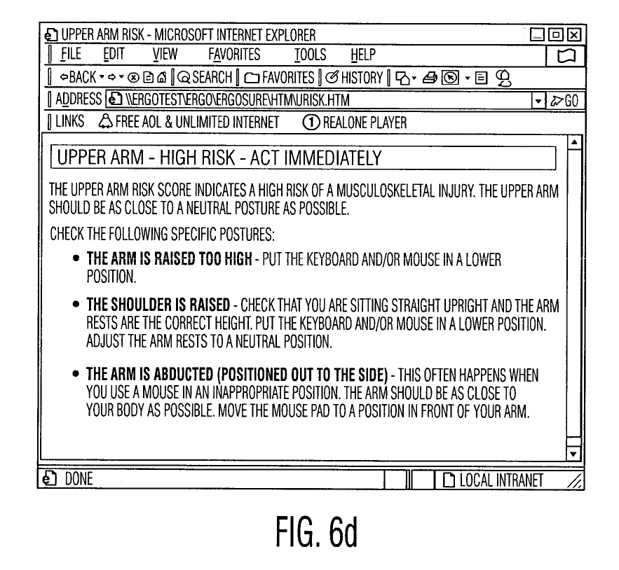

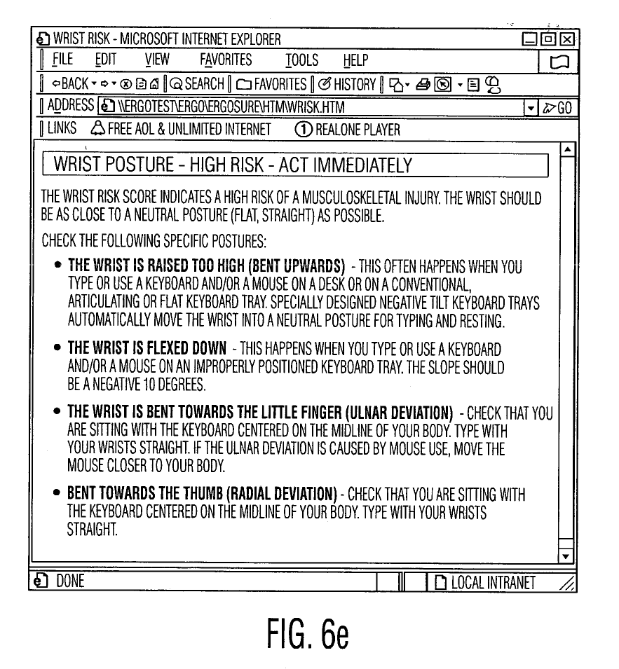

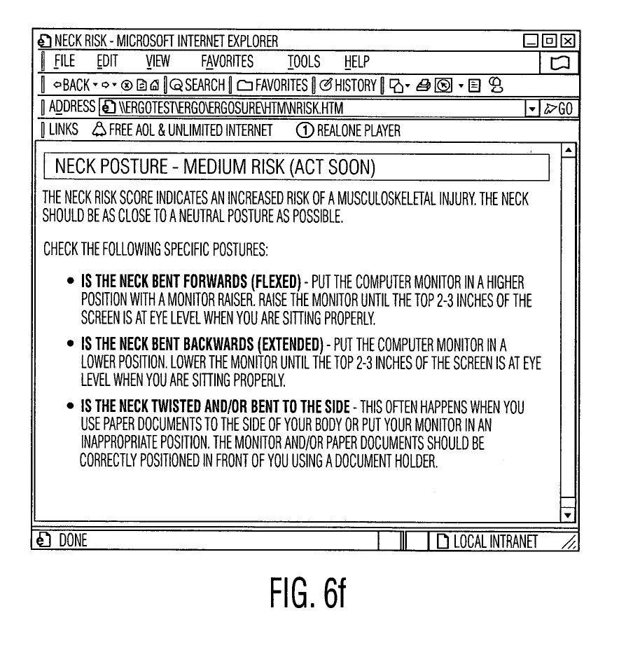

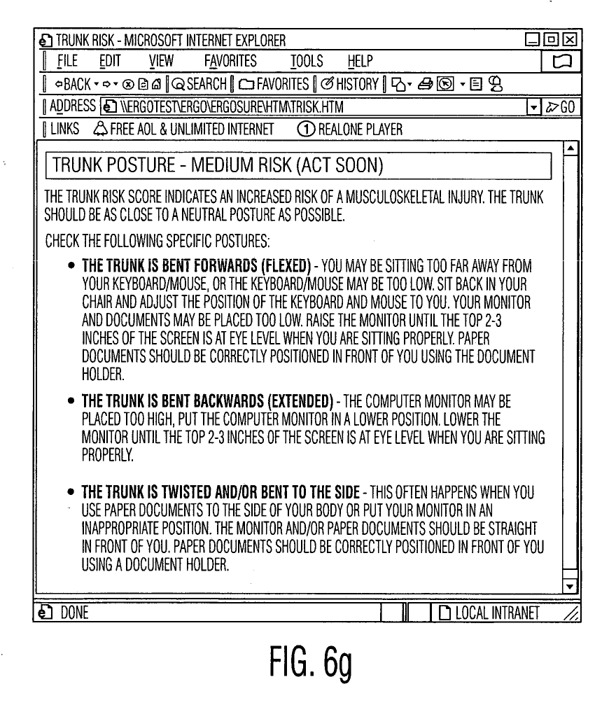

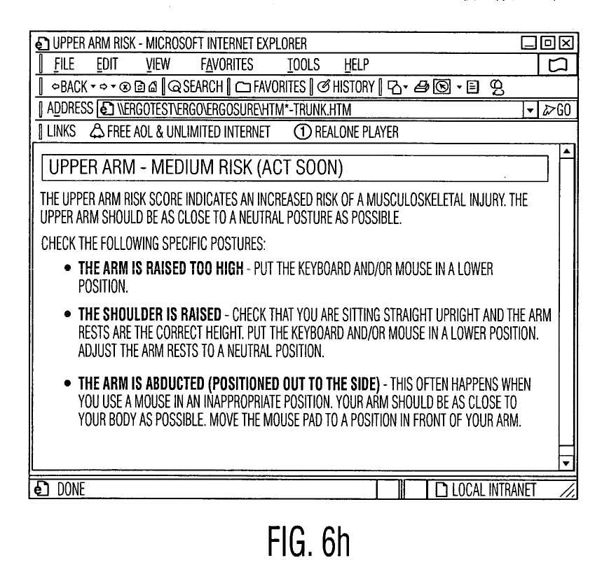

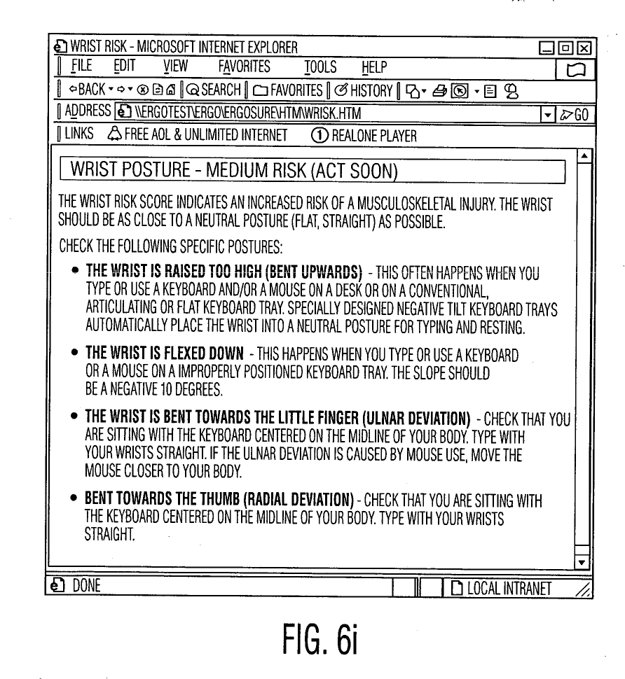

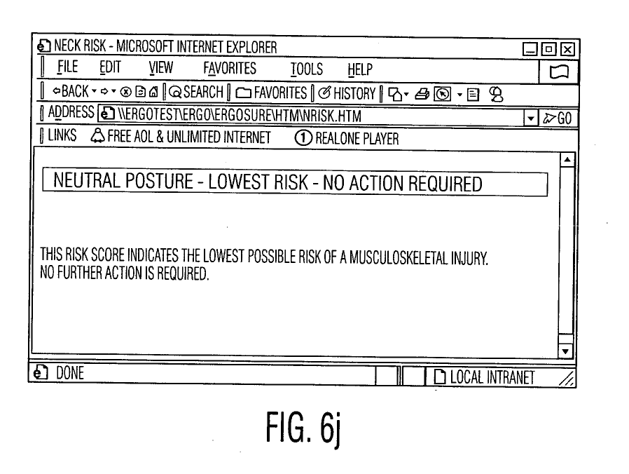

According to an aspect of the invention, additional functionality is provided to the user of the computer. This additional functionality includes the presentation to the user of suggestions as to how to modify his work environment so as to reduce the risk of repetitive stress injury (RSI). FIG. 5 illustrates blocks 36, 42, 43, and 44 as described in conjunction with FIG. 1c. In FIG. 6, the output of logic block 42, in addition to, or instead of, flowing to block 44, also flows over a logic path 610 to a block 612. Block 612 represents the evaluation of the information gathered in conjunction with block 42, and the evaluations performed therewith, to additionally produce suggestions as to how to change the work environment or the user's interaction with the work environment to reduce the risk of RSI. Such a suggestion, in the case of potential injury to the arms, might be to lower the arms while typing, or to lower the keyboard and/or mouse. The actual processor function performed in conjunction with block 612 may be as simple as conversion of the prior-art numeric score into an ergonomic condition. FIGS. 6a, 6b, 6c, 6d, and 6e illustrate screen shots which might conceivably be used in conjunction with block 612 of FIG. 5 for the cases of Rapid Upper Limb Assessment (RULA) assessment of high risk to a body part. FIG. 6a relates to risk to the lower arm, FIG. 6b relates to risk to the neck, FIG. 6c relates to risk to the trunk, FIG. 6d relates to risk to the upper arm, and FIG. 6e relates to risk to the wrist. Similarly, FIGS. 6f, 6g, 6h, and 6i illustrate screen shots which might be used in conjunction with block 612 of FIG. 5 for RULA assessment of medium risk to a body part. FIG. 6f relates to risk to the neck, FIG. 6g relates to risk to the trunk, FIG. 6h relates to risk to the upper arm, and FIG. 6i relates to risk to the wrist. The screen shot illustrated in FIG. 6j might be used in cases of low assessed risk. The screen shots associated with block 612 of FIG. 5 include statements or suggestions as to the nature of the assessed problem. Such suggestions make concrete and readily understood the risk rating which might otherwise be the sole indication of a problem.

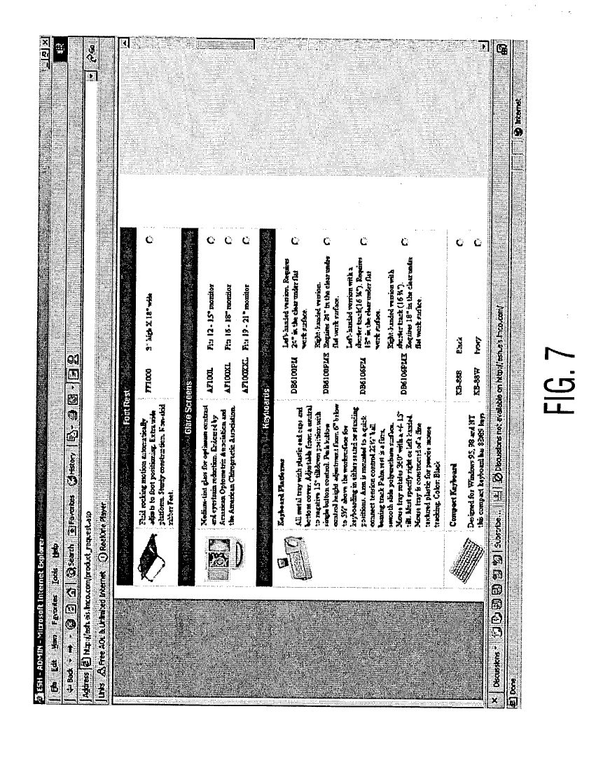

From block 612 of FIG. 5, the logic further flows to a block 614 according to another aspect of the invention. Block 614 represents the presentation to the user of various commercially available equipments or furniture which may be of aid in accomplishing the changes suggested in conjunction with block 612. The processor may, to perform this function, merely access a database which associates a list of equipments with the ergonomic problems. FIG. 7 is a screen shot which presents information and illustrations of relevant equipments in the form of a footrest with adjustable angular position, a glare screen, and keyboards and keyboard platforms.

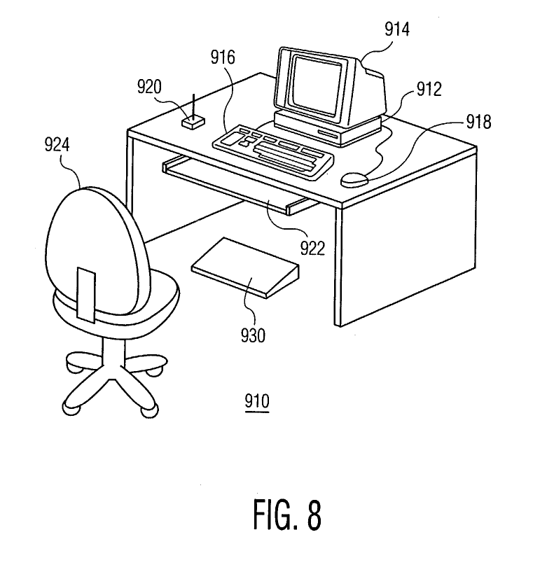

FIG. 8 illustrates a computer workstation 910 including a processor 912, monitor 914, keyboard 916, mouse 918, and ancillary input device 920, and also including a keyboard tray 922 and chair 924. A footrest designated 930 sits below the keyboard tray 922.

Other embodiments of the invention will be apparent to those skilled in the art. For example, the invention may, in principle, be applied to equipments requiring interaction with the user which are other than computers. For example, the driver (or even a passenger) of an automobile or other vehicle might make use of a system according to an aspect of the invention, using either a dedicated processor and display to perform the tasks, or using processors and displays associated with the automobile itself. Similarly, users of other equipment, such as bulldozers or concrete mixers, might find the invention useful.

Thus, a method according to an aspect of the invention is for operating a system (910) including a processor (912). The method comprises the steps of providing a user of the system (910) with the opportunity to self-characterize (42) the interrelation of at least one user body part with the system (910), and using the processor (912) to assign a score (43) to the reported self-assessment. The processor (912) is used to provide information (612), based on the score, about user condition and the interrelation of user with the system (910) to reduce risk of injury. In a particular version of this aspect, the method further includes the step (614) of presenting to the user a list including at least one corrective product which may be useful in the adjustment of the interrelationship. The system (910) may include ancillary equipment associated with a computer processor (912). The ancillary equipment may include at least one of a monitor (914), chair (924), keyboard (916), mouse (918), ancillary input device (920), keyboard tray (922), and footrest (930).

According to another avatar of the invention, a computerized method for avoiding an ergonomic condition comprises the steps of monitoring user operation (42) and characterization of the user's mode of operation (43). This avatar also includes computerized assessment (612) of the characterization, and generation of recommendations for ergonomic improvement of the mode of operation. In this avatar, a further step (614) may include recommending to the user one or more products which may aid in the ergonomic improvement.

A further mode of the method of the invention includes operating a computer (912) including at least a monitor (914), keyboard (916), or mouse (918). The method of this mode comprises the steps of (a) receiving from a user self-characterization (42) of the user's manner of operation of at least one of the monitor, keyboard, mouse, or other associated ergonomically important elements, (b) using the computer, evaluating the self-characterization to produce a score (43) indicative of risk of injury due to interaction of the user with the monitor, keyboard, mouse, or other associated ergonomically important element, and (c) assessing the worker based upon the score and the self-assessment (612), and recommending means for correction (614) of the interaction of the user with the monitor, keyboard, mouse, or other associated ergonomically important element. In another version of this mode, the step of assessing the worker includes assessing the condition of the worker. The step of recommending means for correction may be performed with the aid of an assessment database. This mode may include the step of (d) relating the means for correction to at least one corrective product of a database of corrective products. The corrective products may include one or more of an ergonomic keyboard, keyboard tray, mouse, chair, and footrest.

In a further manifestation of the invention, a method includes providing a user of an equipment with the opportunity (42) to self-characterize the interrelation of at least one user body part with the equipment, and, using a processor (912), assigning a score (43) to the reported self-characterization. The method according to this further manifestation further includes using the processor (912), and in response to the score, providing information (612) about user condition and interrelation of the user with the equipment to reduce risk of injury.

An embodiment of the invention includes a system (910) including a processor (912) and a working environment associated with the system (910). The system (910) comprises means (42) for providing a user of the system (910) with the opportunity to self-characterize the interrelation of at least one user body part with the working environment, and means (43), using the processor (912), for assigning a score to the reported self-characterization. The system (910) of this embodiment also includes means (612), using the processor (912), and based on the score, for providing information about user condition and interrelation of user with the working environment to reduce risk of injury.

What is claimed is:

1. A method for operating a system including a processor, said method comprising the steps of:
using the system to self-characterize the interrelation of at least one user body part with said system;
using said processor to assign a score corresponding to the self-characterization; and
using said processor to provide information, based on said score, about user condition and interrelation of the user with the system to reduce risk of injury.

2. A method according to claim 1, further comprising the step of presenting to said user a list including at least one corrective product which may be useful in adjustment of said interrelation.

3. A method according to claim 1, wherein said system comprises ancillary equipment associated with a computer processor.

4. A method according to claim 3, wherein said ancillary equipment includes at least one of a monitor, chair, keyboard, mouse, ancillary input device, keyboard tray, and footrest.

5. A computerized method for avoiding an ergonomic condition, said method comprising the steps of:
monitoring user operation;
characterization of the user's mode of operation; and
computerized assessment of said characterization and generation of recommendations for ergonomic improvement of said mode of operation.

6. A method according to claim 4, further comprising the step of recommending to said user one or more products which may aid in said ergonomic improvement.

7. A method for operating a computer including at least a monitor, keyboard, or mouse, said method comprising the steps of
(a) receiving from a user self-characterization of the user's manner of operation of at least one of said monitor, keyboard, mouse, or other associated ergonomically important elements;
(b) using said computer, evaluating said self-characterization to produce a score indicative of risk of injury due to interaction of said user with said monitor, keyboard, mouse, or other associated ergonomically important element;
c) assessing the worker based upon said score and said self-assessment, and recommending means for correction of said interaction of said user with said monitor, keyboard, mouse, or other associated ergonomically important element.

7. A method according to claim 6, wherein said step of assessing the worker includes assessing the condition of said worker.

8. A method according to claim 6, wherein said step of recommending means for correction is performed with the aid of an assessment database.

9. A method according to claim 6, further comprising the step of
(d) relating said means for correction to at least one corrective product of a database of corrective products.

10. A method according to claim 9, wherein said at least one corrective product includes at least one of an ergonomic keyboard, keyboard tray, mouse, chair, and footrest.

12. A system including a processor and a working environment associated with said system, said system comprising:
means for providing a user of said system with the opportunity to self-characterize the interrelation of at least one user body part with said working environment;
means, using said processor, for assigning a score to the self-characterization; and
means, using said processor, and based on said score, for providing information about user condition and interrelation of user with said working environment to reduce risk of injury.

13. A method for operating equipment, said method comprising the steps of:
providing a user of said equipment with the opportunity to self-characterize the interrelation of at least one user body part with said equipment;
using a processor, assigning a score to the self-characterization; and
using said processor and in response to said score, providing information about user condition and interrelation of the user with said equipment to reduce risk of injury.
